(19) United States
(12) Patent Application Publication
(10) Pub. No.: US 2023/0331907 A1
(43) Pub. Date: Oct. 19, 2023

(54) SHRINKABLE POLYESTER FILMS

(71) Applicant: Eastman Chemical Company, Kingsport, TN (US)

(72) Inventors: Huamin Hu, Johnson City, TN (US); Marc Alan Strand, Kingsport, TN (US); Jacob E. Napierala, Cleveland, TN (US); Jeffery Earl Grant Powell, Blountville, TN (US); Mark Allen Peters, Jonesborough, TN (US)

(73) Assignee: Eastman Chemical Company, Kingsport, TN (US)

(21) Appl. No.: 18/247,820

(22) PCT Filed: Oct. 8, 2021
(86) PCT No.: PCT/US2021/054079

§ 371 Date: Apr. 4, 2023

Related U.S. Application Data
(60) Provisional application No. 63/198,295, filed on Oct. 8, 2020.

(51) Int. Cl. C08G 63/672; C08G 63/199; C08J 5/18; B65D 23/14; B65D 25/20

(52) U.S. Cl. CPC C08G 63/672; C08G 63/199; C08J 5/18; B65D 23/14; B65D 25/205; C08J 2367/02; B65D 2203/02

(57) ABSTRACT

The invention provides shrinkable films comprised of polyesters comprising certain combinations of glycols and diacids in particular proportions. These polyesters afford certain advantageous properties in the resulting shrinkable films, and thus are suitable as drop-in replacements for commercially available shrink films made using poly(vinyl chloride).

### FIELD OF THE INVENTION

The invention relates generally to shrinkable polyester films comprising polyesters comprising a combination of certain diacid and diol residues in certain compositional ranges having improved properties.

### BACKGROUND OF THE INVENTION

Thermoshrinkable plastic films are used as coverings, to hold objects together, and as an outer wrapping for bottles, cans and other kinds of containers. For example, such films are used for covering the cap, neck, shoulder or bulge of bottles or the entire bottle for the purpose of labeling, protection, parceling, or increasing the value of the product. The uses mentioned above take advantage of the shrinkability created by the internal shrink stress of the film. The films must be tough, must shrink in a controlled manner, and must provide enough shrink force to hold itself on the bottle without crushing the contents. Thermoshrinkable films can be made from a variety of raw materials to meet a range of material demands.

One of the most widely used starting materials for the manufacture of shrinkable plastic films is poly(vinyl chloride) (PVC) and a smaller but significant quantity of shrinkable films are made from oriented polystyrene (OPS). Historically, shrinkable films made with PVC or OPS were used because of the combination of their price and performance. From a performance perspective, PVC-based and OPS-based shrinkable films have a slow shrink rate, a low shrink force, an early onset shrinkage temperature, and a low ultimate or maximum shrinkage. Shrinkable films made with OPS and PVC can be applied to poly(ethylene terephthalate) PET containers but are often used on high-density polyethylene (HDPE) containers where the shrink rate, the onset of shrinkage temperature, and the shrink force are critical to the application. Shrinkable films made with these materials are well-suited to be applied to bottles using a hot air shrink tunnel, where high temperatures and large temperature gradients are commonly present. This film performance criteria is thus advantageously matched with simple bottle designs for moisture-sensitive products like nutraceuticals and pharmaceuticals where the label is commonly applied using a hot air shrink tunnel to package moisture-sensitive products.

Polyester shrink film compositions have been used commercially to produce shrink film labels for food, beverage, personal care, household goods, etc. Polyester compositions can be designed such that shrinkable films made with these resins have a range of favorable performance criteria. Polyester-based shrinkable films can be designed to shrink rapidly between 65° and 80° C., have minimal shrinkage in the direction orthogonal to the main shrinkage direction, to have a maximum shrinkage greater than 70%, and to have a reasonable shrink force. Polyester-based thermoshrinkable film compositions have been used commercially as shrink film labels for food, beverage, personal care, household goods, etc. Often, these shrink films are used in combination with a clear polyethylene terephthalate (PET) bottle or container.

Multilayer shrinkable films which have an inner layer of polystyrene and outer layers of polyester (often referred to as “Hybrid” films) have been developed to combine the best of both materials, but these multilayer films often require an adhesive interlayer to bond the outer and inner layers to one another. These multilayer films require special processing equipment during manufacture, special adhesive tie-layers to bond the outer and inner layers (to minimize delamination) and cannot be reused or recycled due to the heterogenous structure of the film. These films possess a combination of favorable OPS properties and polyester properties (low onset of shrinkage temperature, low shrink force, low shrink rate, and high ultimate shrinkage). These films have been used in applications where a complicated bottle design (e.g., wide base and narrow neck) made from HDPE is labelled in a hot air tunnel.

Currently, it is highly desirable that consumer packaging materials be made of materials which can be readily recycled, contain recycled material, or be made with materials that are not considered to be harmful to the environment either as a raw material or as a final polymeric material (styrene, polystyrene, PVC, etc.), as is the case with polyesters. Thus, a need exists for improved shrinkable polyester films having comparable performance to films made with OPS and PVC so they can serve as “drop-in” replacements on current packages and be applied using existing hot air, shrink tunnel equipment. Desired properties for the polyester-based shrink film include the following: (1) a relatively low shrinkage onset temperature, (2) a total shrinkage which increases gradually and in a controlled manner with increasing temperature, (3) a low shrink force to prevent crushing of the underlying container, and (4) an inherent film toughness so as to prevent unnecessary tearing and splitting of the film prior to and after shrinkage. Additionally, providing high ultimate shrinkage (>70%) would be particularly advantageous.

### SUMMARY OF THE INVENTION

The polyesters of the invention are useful in the manufacture of shrinkable films. The shrinkable films of the invention are comprised of polyesters comprising certain combinations of glycols and diacids in particular proportions. These polyesters afford certain advantageous properties in the resulting shrinkable films. In certain embodiments, the Tg will be between about 60 and 75° C. The shrinkage of the films in the main shrinkage direction will be less than about 2% at 60° C., between about 5 and 30% at 65° C., and greater than 70% at about 95° C. Additionally, the shrink films advantageously possess a shrink rate of less than 4%/° C. between 65 and 80° C. (The shrink rate is measured by subtracting the transverse direction shrinkage (TD shrinkage, main shrinkage direction) at 65° C. from the TD shrinkage at 80° C. and then dividing that quantity by 15° C.). The shrink films of the invention also possess a shrink force less than 8 MPa measured at 80° C. (or the stretching temperature).

In general, shrinkable polyester film of the present invention may be prepared by a method comprising the steps of (a) mixing and polymerizing of dibasic acids with diols to obtain a random reactor-grade copolymer resin; (b) melting and pressing the random copolymer resin or extruding the copolyester resin using typical film extrusion equipment to obtain an unstretched film; (c) stretching the unstretched film in the one direction at temperatures between its Tg and Tg+55° C., and (d) evaluating various film properties (including glass transition temperature (Tg), Tm, shrinkage as a function of temperature (shrink curve), shrink rate between 65° C. and 80° C., film toughness, and shrink force).

### BRIEF DESCRIPTION OF THE DRAWINGS

FIG. 1 is a comparison of a shrink curve from the shrink film of Comparative Example 1, Comparative Example 2, and the shrink curve from the film of Example 1.

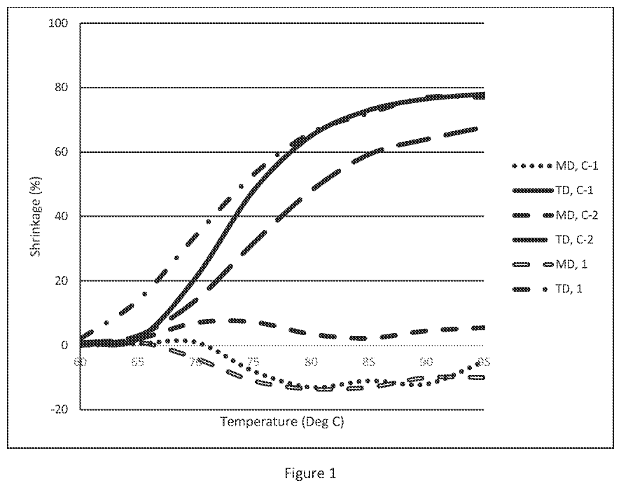

### DETAILED DESCRIPTION OF THE INVENTION

In a first aspect, the invention provides a polyester which comprises:
i. a dicarboxylic acid component comprising:
   1. greater than about 75 mole percent of terephthalic acid residues;
   2. about 0 to about 25 mole percent of residues of 1,4-cyclohexanedicarboxylic acid or succinic acid; and
ii. a diol component comprising:
   1. about 60 to 90 mole percent of ethylene glycol residues; and
   2. about 0 to about 30 mole percent of residues chosen from neopentyl glycol, 1,4-cyclohexanedimethanol, and 2,2,4,4-tetramethyl-1,3-cyclobutanediol; and
   3. about 0 to about 15 mole percent of diethylene glycol residues; and
   4. about 0 to about 35 mole percent of one or more of triethylene glycol, 1,3-propanediol, and 1,4-butanediol;
provided that the diol component is other than 2-methyl-1,3-propanediol,
wherein the total mole percent of the dicarboxylic acid component is 100 mole percent, and wherein the total mole percent of the diol component is 100 percent.

In certain embodiments, the dicarboxylic acid component comprises greater than about 95 mole percent of residues of terephthalic acid, or greater than about 98 mole percent of terephthalic acid, or about 100 mole percent of terephthalic acid. In another embodiment, the dicarboxylic acid component comprises about 8 to about 25 mole percent of residues of 1,4-cyclohexanedicarboxylic acid. In another embodiment, the dicarboxylic acid component comprises about 5 to about 10 mole percent of residues of succinic acid. In another embodiment, the dicarboxylic acid component comprises about 3 to about 15 mole percent of adipic acid.

In other embodiments, the diol component comprises:
a. about 5 to about 30 mole percent of residues of neopentyl glycol; or
b. about 5 to about 30 mole percent of residues of 1,4-cyclohexanedimethanol; or
c. about 5 to about 30 mole percent of residues of 2,2,4,4-tetramethyl-1,3-cyclobutanediol.

In other embodiments, the diol component comprises about 0 to about 14 mole percent of residues of diethylene glycol, whether added intentionally or created in situ. In other embodiments, the diol component comprises about 2 to about 31 mole percent of residues of one or more of triethylene glycol; 1,3-propanediol; 1,4-butanediol.

In other embodiments, the polyester further comprises about 5 to about 25 mole percent of one or more dicarboxylic acid residues chosen from glutaric, azelaic, sebacic, 1,3-cyclohexanedicarboxylic, adipic acid, hexahydrophthalic acid (HHPA), and isophthalic acids.

In other embodiments, the polyester further comprises about 5 to about 30 mole percent of one or more diol residues chosen from 2,2,4-trimethyl-1,3-pentanediol; 2-propoxy-1,3-propanediol; 1,3-cyclohexanediol; and a compound of the formula

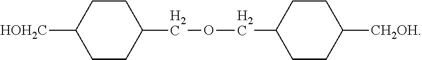 [SMILES: OCC1CCC(COCC2CCC(CO)CC2)CC1]

In other embodiments, in component (ii) 2, the listed diols, i.e., the “about 0 to about 30 mole percent of residues chosen from neopentyl glycol, 1,4-cyclohexanedimethanol, and 2,2,4,4-tetramethyl-1,3-cyclobutanediol;” residues can be chosen from any of the aforementioned diols individually, or an any combination thereof.

In other embodiments, the polyester is one of the following polyesters (A through K):
A. wherein the polyester comprises:
   a. a dicarboxylic acid component comprising:
      i. about 88 to 92 mole percent of residues of terephthalic acid; and
      ii. about 8 to about 12 mole percent of residues of 1,4-cyclohexanedicarboxylic acid; and
   b. a diol component comprising:
      i. about 80 to about 86 mole percent of residues of ethylene glycol; and
      ii. about 16 to about 20 mole percent of residues of 1,4-cyclohexanedimethanol.
B. wherein the polyester comprises:
   a. a dicarboxylic acid component comprising:
      i. about 74 to about 78 mole percent of residues of terephthalic acid; and
      ii. about 22 to about 26 mole percent of residues of 1,4-cylohexanedicarboxylic acid; and
   b. a diol component comprising:
      i. about 88 to about 92 mole percent of residues of ethylene glycol; and
      ii. about 8 to about 12 mole percent of residues of 2,2,4,4-tetramethyl-1,3-cyclobutanediol.
C. wherein the polyester comprises:
   a. a dicarboxylic acid component comprising:
      i. about 91 to about 95 mole percent of residues of terephthalic acid; and
      ii. about 5 to about 9 mole percent of residues of succinic acid; and
   b. a diol component comprising:
      i. about 72 to about 76 mole percent of residues of ethylene glycol;
      ii. about 1 to about 3 mole percent of residues of diethylene glycol; and
      iii. about 22 to about 26 mole percent of residues of neopentyl glycol.
D. wherein the polyester comprises:
   a. a dicarboxylic acid component comprising:
      i. about 98 to about 100 mole percent of residues of terephthalic acid; and
   b. a diol component comprising:
      i. about 60 to about 63 mole percent of residues of ethylene glycol;
      ii. up to about 4 mole percent of residues of diethylene glycol;
      iii. about 4 to about 7 mole percent of residues of neopentyl glycol; and
      iv. about 29 to about 33 mole percent of residues of 1,3-propanediol.
E. wherein the polyester comprises:
   a. a dicarboxylic acid component comprising:
      i. about 98 to about 100 mole percent of residues of terephthalic acid; and
   b. a diol component comprising:
      i. about 60 to about 64 mole percent of residues of ethylene glycol;
      ii. about 3 to about 7 mole percent of residues of 1,4-cyclohexanedimethanol;
      iii. up to about 4 mole percent of residues of diethylene glycol; and
      iv. about 29 to about 33 mole percent of residues of 1,3-propanediol.
F. wherein the polyester comprises:
   a. a dicarboxylic acid component comprising:
      i. about 98 to about 100 mole percent of residues of terephthalic acid; and
   b. a diol component comprising:
      i. about 64 to about 68 mole percent of residues of ethylene glycol;
      ii. about 2 to about 6 mole percent of residues of 2,2,4,4-tetramethyl-1,3-cyclobutanediol; and
      iii. about 29 to about 33 mole percent of residues of 1,3-propanediol.
G. wherein the polyester comprises:
   a. a dicarboxylic acid component comprising:
      i. about 98 to about 100 mole percent of residues of terephthalic acid; and
   b. a diol component comprising:
      i. about 68 to about 72 mole percent of residues of ethylene glycol;
      ii. about 6 to about 10 mole percent of residues of diethylene glycol;
      iii. about 3 to about 7 mole percent of residues of 2,2,4,4-tetramethyl-1,3-cyclobutanediol; and
      iv. about 15 to about 19 mole percent of residues of 1,3-propanediol.
H. wherein the polyester comprises:
   a. a dicarboxylic acid component comprising:
      i. about 98 to about 100 mole percent of residues of terephthalic acid;
   b. a diol component comprising:
      i. about 63 to about 67 mole percent of residues of ethylene glycol;
      ii. up to about 4 mole percent of residues of diethylene glycol;
      iii. about 15 to about 19 mole percent of residues of neopentyl glycol; and
      iv. about 14 to about 18 mole percent of 1,4-butanediol.
I. wherein the polyester comprises:
   a. a dicarboxylic acid component comprising:
      i. about 98 to about 100 mole percent of residues of terephthalic acid;
   b. a diol component comprising:
      i. about 70 to about 74 mole percent of residues of ethylene glycol;
      ii. about 11 to about 15 mole percent of residues of diethylene glycol; and
      iii. about 13 to about 17 mole percent of residues of a compound of the formula:

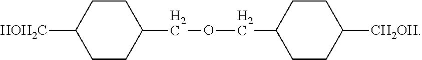 [SMILES: OCC1CCC(COCC2CCC(CO)CC2)CC1]

J. wherein the polyester comprises:
   a. a dicarboxylic acid component comprising:
      i. about 98 to about 100 mole percent of residues of terephthalic acid;
   b. a diol component comprising:
      i. about 60 to about 64 mole percent of residues of ethylene glycol;
      ii. about 12 to about 16 mole percent of residues of diethylene glycol; and
      iii. about 22 to about 26 mole percent of residues of 1,3-cyclohexanedimethanol.
K. wherein the polyester comprises:
   a. a dicarboxylic acid component comprising:
      i. about 85 to 97 mole percent of residues of terephthalic acid;
      ii. about 3 to about 15 mole percent of residues of adipic acid;
   b. a diol component comprising:
      i. about 70 to abut 85 mole percent of residues of ethylene glycol;
      ii. about 0 to about 25 mole percent of residues of 1,4-cyclohexanedimethanol;
      iii. about 0.1 to about 2 mole percent of residues of diethylene glycol;
      iv. about 0 to about 18 mole percent of residues of 2,2,4,4-tetramethyl-1,3-cyclobutanediol; and
      v. about 0 to about 27 mole percent of residues of neopentyl glycol.

Particular examples of such polyesters are set forth below in Examples a through m:

| Example | Composition of polyester by residues of dicarboxylic acid |
|---|---|
| No. | and diol used in their preparation: |
| a | 90 mole percent terephthalic acid; |
| | 10 mole percent 1,4-cyclohexanedicarboxylic acid; |
| | 82 mole percent ethylene glycol; |
| | 18 mole percent 1,4-cyclohexanedimethanol |
| b | 76 mole percent terephthalic acid |
| | 24 mole percent 1,4-cyclohexanedicarboxylic acid; |
| | 90 mole percent ethylene glycol |
| | 10 mole percent 2,2,4,4-tetramethyl-1,3-cyclobutanediol |
| C | 93 mole percent terephthalic acid |
| | 7 mole percent succinic acid |
| | 74 mole percent ethylene glycol |
| | 2 mole percent diethylene glycol |
| | 24 mole percent neopentyl glycol |
| d | 100 mole percent of terephthalic acid |
| | 61.5 mole percent of ethylene glycol |
| | 2 mole percent of diethylene glycol |
| | 5.5 mole percent of neopentyl glycol |
| | 31 mole percent of 1,3-propanediol |
| e | 100 mole percent of terephthalic acid |
| | 62 mole percent of ethylene glycol |
| | 5 mole percent of 1,4-cyclohexanedimethanol |
| | 2 mole percent of diethylene glycol |
| | 31 mole percent of 1,3-propanediol |
| f | 100 mole percent of terephthalic acid |
| | 65.6 mole percent of ethylene glycol |
| | 3.4 mole percent of 2,2,4,4-tetramethyl-1,3-cyclobutanediol |
| | 31 mole percent of 1,3-propanediol |
| g | 100 mole percent of terephthalic acid |
| | 70 mole percent of ethylene glycol |
| | 8 mole percent of diethylene glycol |
| | 5 mole percent of 2,2,4,4-tetramethyl-1,3-cyclobutanediol |
| | 17 mole percent of 1,3-propanediol |
| h | 100 mole percent of terephthalic acid |
| | 65 mole percent of ethylene glycol |
| | 2 mole percent of diethylene glycol |
| | 17 mole percent of neopentyl glycol |
| | 16 mole percent of 1,4-butanediol |
| i | 100 mole percent of terephthalic acid |
| | 72 mole percent of ethylene glycol |
| | 13 mole percent of diethylene glycol |
| | 15 mole percent of a compound of the formula |
| | 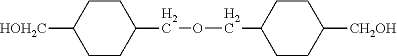 [SMILES: OCC1CCC(COCC2CCC(CO)CC2)CC1] |
| j | 100 mole percent of terephthalic acid |
| | 62 mole percent of ethylene glycol |
| | 14 mole percent of diethylene glycol |
| | 24 mole percent of 1,3-cyclohexanedimethanol |
| k | 87 mole percent of terephthalic acid |
| | 13 mole percent of adipic acid |
| | 82 mole percent of ethylene glycol |
| | <1 mole percent of diethylene glycol |
| | 17 mole percent of 2,2,4,4-tetramethyl-1,3-cyclobutanediol |
| l | 89 mole percent of terephthalic acid |
| | 11 mole percent of adipic acid |
| | 76 mole percent of ethylene glycol |
| | 24 mole percent of 1,4-cyclohexanedimethanol |
| | <1 mole percent of diethylene glycol |
| m | 96 mole percent of terephthalic acid |
| | 4 mole percent of adipic acid |
| | 71 mole percent of ethylene glycol |
| | 2 mole percent of diethylene glycol |
| | 27 mole percent of neopentyl glycol |

In another aspect, the invention provides a shrinkable film, comprising the polyester of any of the above embodiments.

In one embodiment, the shrinkable films of the invention exhibit one or more of the following properties:
A. TD shrinkage @60° C. <2%;
B. TD shrinkage @65° C. between 5 and 30%;
C. TD shrinkage @95° C. >70%;
D. Shrink rate <4%/° C. between 65 and 80° C.;
E. Shrink force <8 MPa;
F. Tg<70° C.;
G. a break strain percentage of greater than 100% at pull rates of 300 mm/minute, or 100 to 300%, or 100 to 500%, or 100 to 800%, in the transverse direction or in the machine direction or in both directions according to ASTM Method D882;
H. No more than 40% shrinkage per 5° C. temperature increase.

Advantageously, the shrinkable films of the invention exhibit one or more of the following properties:
TD shrinkage @60° C. 0%;
TD shrinkage @65° C. between 0 and 35%;
TD shrinkage @95° C. >60%;
Shrink rate <4%/° C. between 65 and 80° C.;
Shrink force <8 MPa, measured at 80° C.;
Tg<70° C.;
a break strain percentage of greater than 100% at pull rates of 300 mm/minute, or 100 to 300%, or 100 to 500%, or 100 to 800%, in the transverse direction or in the machine direction or in both directions according to ASTM Method D882.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make a polyester.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present invention, therefore, may be based on the total moles of acid residues, the total moles of diol residues, or the total moles of repeating units.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present invention. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein.

Esters of terephthalic acid and the other dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, the diol component of the polyester compositions useful in the present invention can comprise 1,4-cyclohexanedimethanol. In another embodiment, the diol component of the polyesters useful in the present invention comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

It should be noted that some other diol residues may be formed in situ during processing. The total amount of diethylene glycol residues can be present in the polyester, whether or not formed in situ, in a total amount when present of up to about 15 mole percent.

In some embodiments, the polyesters according to the present invention can comprise from 0 to 10 mole %, for example, from 0.01 to 5 mole %, from 0.01 to 1 mole %, from 0.05 to 5 mole %, from 0.05 to 1 mole %, or from 0.1 to 0.7 mole %, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In some embodiments, the polyester(s) useful in the present invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole % of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, incorporated herein by reference.

The polyesters of the invention can also comprise at least one chain extender. Suitable chain extenders include, but are not limited to, multifunctional (including, but not limited to, bifunctional) isocyanates, multifunctional epoxides, including, for example, epoxylated novolac polymers, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion.

The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

It is contemplated that polyesters of the present invention can possess at least one of the inherent viscosity ranges described herein and at least one of the monomer ranges for the polyesters described herein, unless otherwise stated. It is also contemplated that polyesters useful in the present invention can possess at least one of the Tg ranges described herein and at least one of the monomer ranges for the polyesters described herein, unless otherwise stated. It is also contemplated that polyesters useful in the present invention can possess at least one of the inherent viscosity ranges described herein, at least one of the Tg ranges described herein, and at least one of the monomer ranges for the polyesters described herein, unless otherwise stated.

In certain embodiments, the polyesters useful in the invention can exhibit at least one of the following inherent viscosities as determined in 60/40 (weight/weight) phenol/tetrachloroethane at a concentration of 0.25 g/50 ml at 25° C.: 0.50 to 1.2 dL/g; 0.50 to 1.0 dL/g; 0.50 to 0.90 dL/g; 0.50 to 0.80 dL/g; 0.55 to 0.80 dL/g; 0.60 to 0.80 dL/g; 0.65 to 0.80 dL/g; 0.70 to 0.80 dL/g; 0.50 to 0.75 dL/g; 0.55 to 0.75 dL/g; or 0.60 to 0.75 dL/g. In one embodiment, the inherent viscosity is 0.65-0.75. ASTM 5225

The glass transition temperature (Tg) of the polyesters is determined using a TA DSC 2920 from Thermal Analyst Instrument at a scan rate of 20° C./minute. ASTM E 1356

In certain embodiments, the oriented films or shrink films of the invention comprise a polyester wherein the polyester has a Tg of 60 to 80° C.; 70 to 80° C.; or 65 to 80° C.; or 65 to 75° C. In one embodiment, the Tg is 60-75° C. In certain embodiments, these Tg ranges can be met with or without at least one plasticizer being added during polymerization. ASTM E1356

In one embodiment, the polyesters of the invention can be visually clear. The term “visually clear” is defined herein as an appreciable absence of cloudiness, haziness, and/or muddiness, when inspected visually.

The polyesters useful in this disclosure can be made by processes known from the literature, for example, by processes in homogenous solution, by transesterification processes in the melt, and by two phase interfacial processes. Suitable methods include, but are not limited to, the steps of reacting one or more dicarboxylic acids with one or more diols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general may be prepared by condensing the dicarboxylic acid or dicarboxylic acid ester with the diol in the presence of a catalyst at elevated temperatures increased gradually during the course of the condensation up to a temperature of about 225° C. to 310° C., in an inert atmosphere, and conducting the condensation at low pressure during the latter part of the condensation, as described in further detail in U.S. Pat. No. 2,720,507 incorporated herein by reference herein.

In some embodiments, during the process for making the polyesters useful in the present invention, certain agents which colorize the polymer can be added to the melt including toners or dyes. In one embodiment, a bluing toner is added to the melt in order to adjust the b* of the resulting polyester polymer melt phase product. Such bluing agents include blue inorganic and organic toner(s) and/or dyes. In addition, red toner(s) and/or dyes can also be used to adjust the a* color. In one embodiment, the polymers useful in the invention and/or the polymer compositions of the invention, with or without toners, can have color values L*, a* and b* which can be determined using a Hunter Lab Ultrascan Spectra Colorimeter manufactured by Hunter Associates Lab Inc., Reston, Va. The color determinations are averages of values measured on either pellets or powders of the polymers or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Advantageously, the toner(s) are added to the esterification zone or to the early stages of the polycondensation zone, such as to a pre-polymerization reactor or added in an extruder

In certain embodiments, the polyester compositions can also contain from 0.01 to 25% by weight of the overall composition common additives such as colorants, dyes, mold release agents, flame retardants, plasticizers, glass bubbles, voiding agents, nucleating agents, stabilizers, including but not limited to, UV stabilizers, thermal stabilizers, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

In another aspect, the invention provides shrink film(s) and molded article(s) of this disclosure comprising the polyesters as described herein. The methods of forming the polyesters into film(s) and/or sheet(s) are well known in the art. Examples of film(s) and/or sheet(s) useful the present invention include but not are limited to extruded film(s) and/or sheet(s), compression molded film(s), calendered film(s) and/or sheet(s), solution casted film(s) and/or sheet(s). In one aspect, methods of making film and/or sheet useful to produce the shrink films of the present invention include but are not limited to extrusion, compression molding, calendering, and solution casting.

Accordingly, in another aspect, the invention provides a molded article, thermoformed sheet, extruded sheet or film, comprising the polyesters of the various embodiments herein.

The shrink films of the invention can have an onset of shrinkage temperature of from about 55 to about 80° C., or about 55 to about 75° C., or about 55 to about 70° C. Onset shrinkage temperature is the lowest temperature at which shrinkage occurs.

In certain embodiments, the polyesters of the invention can have densities of 1.6 g/cc or less, or 1.5 g/cc or less, or 1.4 g/cc or less, or 1.1 g/cc to 1.5 g/cc, or 1.2 g/cc to 1.4 g/cc, or 1.2 g/cc to 1.35 g/cc. In one embodiment, the polyesters of the invention have densities of 1.2 g/cc to 1.3 g/cc.

One approach for reducing the density is to introduce many small voids or holes into the shaped article. This process is called “voiding” and may also be referred to as “cavitating” or “microvoiding”. Voids are obtained by incorporating about 5 to about 50 weight % of small organic or inorganic particles or “inclusions” (referred in the art as “voiding” or “cavitation” agents) into a matrix polymer and orienting the polymer by stretching in at least one direction. Additionally, the use of immiscible or incompatible resins can create voids. During stretching, small cavities or voids are formed around the voiding agent. When voids are introduced into polymer films, the resulting voided film not only has a lower density than the non-voided film, but also becomes opaque and develops a paper-like surface. This surface also has the advantage of increased printability; that is, the surface is capable of accepting many inks with a substantially greater capacity over a non-voided film. Typical examples of voided films are described in U.S. Pat. Nos. 3,426,754; 3,944,699; 4,138,459; 4,582,752; 4,632,869; 4,770,931; 5,176,954; 5,435,955; 5,843,578; 6,004,664; 6,287,680; 6,500,533; 6,720,085; each of which is incorporated herein by reference, along with U.S. Patent Application Publication Numbers 2001/0036545; 2003/0068453; 2003/0165671; 2003/0170427; Japan Patent Application No.'s 61-037827; 63-193822; 2004-181863; European Patent No. 0 581 970 B1, and European Patent Application No. 0 214 859 A2.

In certain embodiments, the as-extruded films are oriented while they are stretched. The oriented films or shrinkable films of the present invention can be made from films having any thickness depending on the desired end-use. The desirable conditions are, in one embodiment, where the oriented films and/or shrinkable films can be printed with ink for applications including labels, photo films which can be adhered to substrates such as paper, and/or other applications that it may be useful in. It may be desirable to coextrude the polyesters useful in the present invention with another polymer, such as PET, to make multilayer films useful in making the oriented films and/or shrink films of this disclosure. One advantage of doing the latter is that a tie layer may not be needed in some embodiments. Another advantage of a multilayer film is that is combines the performance of dissimilar materials into a single structure.

In one embodiment, the monoaxially and biaxially oriented films of the present invention can be made from films having a thickness of about 100 to 400 microns, for example, extruded, cast or calendared films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as extruded film can be performed on a tenter frame according to these orientation conditions. The shrink films of the present invention can be made from the oriented films as described herein.

In certain embodiments, the shrink films of the present invention have gradual shrinkage with little to no wrinkling. In certain embodiments, the shrink films of the present invention have no more than 40% shrinkage in the transverse direction per 5° C. temperature increase increment.

In certain embodiments of the invention, the shrink films have shrinkage in the machine direction of from 4% or less, or 3% or less, or 2.5% or less, or 2% or less, or no shrinkage when immersed in water at 65° C. for 10 seconds. In certain embodiments, the shrink films have shrinkage in the machine direction of from −15% to 5%, −5% to 4%, −5% to 3%, or −5% to 2.5%, or −5% to 2%, or −4% to 4%, or −3% to 4% or −2% to 4%, or −2% to 2.5%, or −2% to 2%, or 0 to 2%, or no shrinkage, when immersed in water at 65° C. for 10 seconds. Negative machine direction shrinkage percentages here indicate machine direction growth. Positive machine direction shrinkages indicate shrinkage in the machine direction.

In certain embodiments, the shrink films have shrinkage in the main shrinkage direction of from 50% or greater, or 60% or greater, or 70% or greater, when immersed in water at 95° C. for 10 seconds.

In certain embodiments, the shrink films have shrinkage in the main shrinkage direction in the amount of 50 to 80% and shrinkage in the machine direction of 4% or less, or from −15% to 5%, when immersed in water at 95° for 10 seconds.

In one embodiment, the polyester compositions of the invention are made into films using any method known in the art to produce films from polyesters, for example, solution casting, extrusion, compression molding, or calendering. The as-extruded (or as-formed) film is then oriented in one or more directions (e.g., monoaxially and/or biaxially oriented film). This orientation of the films can be performed by any method known in the art using standard orientation conditions. For example, the monoaxially oriented films of the present invention can be made from films having a thickness of about 100 to 400 microns, such as, extruded, cast or calendered films.

The films can then enter a zone where they can be preheated at temperatures between the Tg of the film and the Tg+50 C. After preheating, the film enters a zone where the film is stretched and the film can be stretched at a ratio of 6.5:1 to 3:1 at a temperature of from the Tg of the film to the Tg+55° C., and which can be stretched to a thickness of 20 to 80 microns.

The film can then be annealed, or thermally treated, at a temperature 10 degrees below the Tg of the film to a temperature 10 degrees above the Tg to tailor the properties of the film to meet certain requirements.

In one embodiment, the orientation of the initial as extruded film can be performed on a tenter frame according to these orientation conditions.

In certain embodiments, the shrink films of this disclosure have no more than 40% shrinkage in the transverse direction per 5° C. temperature increase increment.

In certain embodiments, the shrink films can have an onset of shrinkage temperature of from about 55 to about 80° C., or about 55 to about 75° C., or 55 to about 70° C. “Onset of shrinkage temperature” is the temperature at which onset of shrinking occurs.

In certain embodiments, the shrink films can have an onset of shrinkage temperature of between 55° C. and 70° C.

In certain embodiments, the shrink films can have a break strain percentage greater than 100% at a stretching speed of 300 mm/minute in the direction orthogonal to the main shrinkage direction according to ASTM Method D882.

In certain embodiments, the shrink films can have a break strain percentage of greater than 300% at a stretching speed of 300 mm/minute in the direction orthogonal to the main shrinkage direction according to ASTM Method D882.

In certain embodiments, the shrink films can have a tensile stress at break (break stress) of from 20 to 400 MPa; or 40 to 260 MPa; or 42 to 260 MPa as measured according to ASTM Method D882.

In certain embodiments, the shrink films can have a shrink force of from 4 to 18 MPa, or from 4 to 15 MPa, as measured by ISO Method 14616 depending on the stretching conditions and the end-use application desired. For example, certain labels made for plastic bottles can have an MPa of from 4 to 8 and certain labels made for glass bottles can have a shrink force of from 10 to 14 MPa as measured by ISO Method 14616 using a Shrink Force Tester made by LabThink at 80° C.

In one embodiment, the polyesters can be formed by reacting the monomers by known methods for making polyesters in what is typically referred to as reactor grade polyesters.

Reinforcing materials can be added to the polyester compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

Molded articles can also be manufactured from any of the polyesters disclosed herein which may or may not consist of or contain shrink films and are included within the scope of the present invention.

Generally, the shrink films of the invention may contain from 0.01 to 10 weight percent of a polyester plasticizer, when present. In this regard, useful polyester plasticizers can be those described in U.S. Pat. No. 10,329,395, incorporated herein by reference. In general, such polyester plasticizers are characterized by comprising (i) a polyol component comprising residues of a polyol having 2 to 8 carbon atoms, and (ii) a diacid component comprising residues of a dicarboxylic acid having 4 to 12 carbon atoms. In one embodiment, the shrink films can contain from 0.1 to 5 weight percent of the polyester plasticizer. Generally, the shrink films can contain from 90 to 99.99 weight percent of the copolyester. In certain embodiments, the shrink films can contain from 95 to 99.9 weight percent of the copolyester.

In one embodiment, when having a pre-oriented thickness of about 100 to 400 microns and then oriented on a tenter frame at from a ratio of 6.5:1 to 3:1 at a temperature of from Tg to Tg+55° C. to a thickness of from about 20 to about 80 microns, the shrink films of the present invention can have one or more of the following properties:
TD shrinkage @60° C. 0%;
TD shrinkage @65° C. between 0 and 35%;
TD shrinkage @95° C. >60%;
Shrink rate <4%/° C. between 65 and 80° C.;
Shrink force <8 MPa, measured at 80° C.;
Tg<70° C.;
a break strain percentage of greater than 100% at pull rates of 300 mm/minute, or 100 to 300%, or 100 to 500%, or 100 to 800%, in the transverse direction or in the machine direction or in both directions according to ASTM Method D882.

Any combination of these properties or all of these properties can be present in the shrink films of this invention. The shrink films of the present invention can have a combination of two or more of the above described shrink film properties. The shrink films of the present invention can have a combination of three or more of the above described shrink film properties. The shrink films of the present invention can have a combination of one or more of the above described shrink film properties. In certain embodiments, properties (A)-(H) are present. In certain embodiments, properties (A)-(B) are present. In certain embodiments, properties (A)-(C) are present, etc.

The shrinkage percentages herein are based on films having a thickness of about 20 to 80 microns that have been oriented at a ratio of from 6.5:1 to 3:1 at a temperature of Tg to Tg+55° C. on a tenter frame, for example, at a ratio of 5:1 at a temperature from 70° C. to 85° C. In one embodiment, the shrinkage properties of the oriented films used to make the shrink films of this disclosure were not adjusted by annealing the films at a temperature higher than the temperature in which it was oriented. In another embodiment, the film properties are adjusted by annealing, by heat treatment before or after stretching.

The shape of the films useful in making the oriented films or shrink films of the present invention is not restricted in any way. For example, it may be a flat film or a film that has been formed into a tube. In order to produce the shrink films useful in the present invention, the polyester is first formed into a flat film and then is “uniaxially stretched”, meaning the polyester film is oriented in one direction. The films could also be “biaxially oriented,” meaning the polyester films are oriented in two different directions; for example, the films are stretched in both the machine direction and a direction different from the machine direction. Typically, but not always, the two directions are substantially perpendicular. For example, in one embodiment, the two directions are in the longitudinal or machine direction (“MD”) of the film (the direction in which the film is produced on a film-making machine) and the transverse direction (“TD”) of the film (the direction perpendicular to the MD of the film). Biaxially oriented films may be sequentially oriented, simultaneously oriented, or oriented by some combination of simultaneous and sequential stretching.

The films may be oriented by any usual method, such as the roll stretching method, the long-gap stretching method, the tenter-stretching method, and the tubular stretching method. With use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also, the stretching may be done first in one direction and then in the other direction to result in effective biaxial stretching. In one embodiment, stretching of the films is done by preliminarily heating the films at a temperature which is from their Tg to 55° C. above their glass transition temperature (Tg). In one embodiment, the films can be preliminarily heated from 0° C. to 30° C. above their Tg. In one embodiment, the stretch rate is from 0.04 to 35 inches (0.10 to 90.0 cm) per second. Next, the films can be oriented, for example, in either the machine direction, the transverse direction, or both directions from 2 to 6 times the original measurements. The films can be oriented as a single film layer or can be coextruded with another polyester such as PET (polyethylene terephthalate) as a multilayer film and then oriented.

In another aspect, the invention provides an article of manufacture or a shaped article comprising the shrink films of any of the shrink film embodiments as set forth herein. In another embodiment, the invention provides an article of manufacture or a shaped article comprising the oriented films of any of the oriented film embodiments of this disclosure.

In certain embodiments, the invention provides but is not limited to shrink films applied to containers, plastic bottles, glass bottles, packaging, batteries, hot fill containers, and/or industrial articles or other applications. In one embodiment, the present invention includes but is not limited to shrinkable films applied to containers, packaging, plastic bottles, glass bottles, photo substrates such as paper, batteries, hot fill containers, and/or industrial articles or other applications.

In certain embodiments, the shrink films of this invention can be formed into a label or sleeve. The label or sleeve can then be applied to an article of manufacture, such as, the wall of a container, battery, or onto a sheet or film. Accordingly, in another aspect, the invention provides an article of manufacture, a shaped article, a container, a plastic bottle, a cup, a glass bottle, packaging, a battery, a hot fill container, or an industrial article, having applied thereto a label or sleeve, wherein said label or sleeve is comprised of the shrink film of the invention as set forth herein in various embodiments. For example, the shrink films of the present invention can be used in many packaging applications where the shaped article exhibits properties, such as, good printability, high opacity, higher shrink force, good texture, and good stiffness.

Accordingly, the compositions of the invention thus provide a combination of improved shrink properties as well as improved toughness, and thus are expected to offer new commercial options, including but not limited to, shrink films applied to containers, plastic bottles, glass bottles, packaging, batteries, hot fill containers, and/or industrial articles or other applications.

As set forth in the Experimental Section below, in the synthesis of Comparative Examples 1 through 4 and Examples 1 through 13, monomers have been polymerized to high conversion to produce a high molecular weight copolyester that is characterized by an inherent viscosity (I.V.) in the range of 0.5-0.9 dL/g, where an inherent viscosity, measured in a 60/40 parts by weight solution of phenol/tetrachloroethane at 250° C. and at a concentration of about 0.25 g of polymer in 50 mL of said solvent, of at least 0.5 dL/g is required for minimal polymer physical properties.

The Tg of the polyesters is in one embodiment about 50° C. to about 80° C. In another embodiment, the Tg of the polyesters is about 58° C. to about 71° C.

The processes known for preparing polyesters are used for this invention and involve an ester-interchange or esterification stage followed by a polycondensation stage. Advantageously, polyester synthesis can be performed as a melt phase process in the absence of organic solvents. The ester-interchange or esterification can be conducted under an inert atmosphere at a temperature of about 150° C. to about 280° C. for about 0.5 to about 8 hours, or from about 180° C. to about 240° C. for about 1 to about 4 hours. The monomers (diacids or diols) vary in reactivity, depending on processing conditions, but glycol-functional monomers are commonly used in molar excesses of 1.05 to 3 moles per total moles of acid functional monomers. The polycondensation stage is advantageously performed under reduced pressure at a temperature of about 220° C. to about 350° C., or about 240° C. to about 300° C., or about 250° C. to about 290° C. for about 0.1 to about 6 hours, or from about 0.5 to about 3 hours. The reactions during both stages are facilitated by the judicious selection of catalysts known by those skilled in the art, including but not limited to alkyl and alkoxy titanium compounds, alkali metal hydroxides and alkoxides, organotin compounds, germanium oxide, organogermanium compounds, aluminum compounds, manganese salts, zinc salts, rare earth compounds, antimony oxide, and so forth. Phosphorous compounds may be used as stabilizers to control color and reactivity of residual catalysts. Typical examples are phosphoric acid, phosphonic acid, and phosphate esters, such as Merpol™ A, a product of Stepan Chemical Company.

Film fabrication is accomplished by all known means to convert resin samples to films. For small, lab-scale samples, lab-scale pressing and stretching methods can be utilized. Polymer pellets can be melted at a temperature of 220° C. to 290° C. or from 240° C. to 260° C. and shaped into a film of desired dimensions. For larger samples, copolyester samples can be extruded using single or twin-screw extruders into film at temperatures between about 220° and 290° C. The resulting films (made using extrusion process) may be stretched 2 to 6 times the original dimensions in the direction orthogonal to the extruded or machine direction at a temperature from the Tg of the resin to the Tg+55° C. For film made using the lab-scale process that lack a true machine direction, the samples can be stretched 2 to 6 times the original dimensions in either direction at a temperature from the Tg of the resin to the Tg+55° C. In both cases, preferably stretched in one direction by about 3-5 times more than the orthogonal direction at a temperature from the Tg of the resin to the Tg+55° C. The thickness of the heat-shrinkable polyester film prepared in accordance with the present invention may be 20 μm to 80 μm, or 30 μm to 50 μm.

This invention can be further illustrated by the following examples of certain embodiments thereof, although it will be understood that these examples are included merely for purposes of illustration and are not intended to limit the scope of the invention unless otherwise specifically indicated.

### Experimental Section

Terephthalic Acid/Ethylene Glycol (TPA/EG) Oligomer Synthesis

TPA/EG oligomers were made by feeding a single continuous stirred tank reactor (CSTR) a slurry of PTA (1.73 wt %), EG (98 mole %), and DEG (2 mole %) continuously using a 1.44 feed mole ratio at a rate of 10-23 g/min. The CSTR reactor level was kept constant at a reaction temperature of 260° C. via continuous removal of the TPA/EG oligomer product and separation/removal of the water of reaction via distillation under pressure (30 psig). TPA/EG oligomer batches were then combined to create a starting material to make new compositions.

Copolyester Synthesis

Polymerizations were conducted with Ti catalyst. Depending on the composition, the synthesis is either started with TPA/EG oligomer (TPA-based) or DMT. After set-up of the polymerization, all reactions were performed on computer automated polymer rigs equipped with Camille Tg™ software. The Camille-recipe is shown in Table 1. On the left is the Camille recipe starting from TPA/EG oligomer, and on the right is the Camille recipe starting from DMT. A description for making Comparative Example 1 is as follows. Making this composition involved a typical synthesis from TPA/EG oligomer and is described as follows: TPA/EG oligomer (100 g, 0.52 mol), CHDM (17.58 g, 0.12 mol), DEG (6.72 g, 0.063 mol) and 0.33 wt % Ti solution (0.5 g) were charged into a 500 mL round bottom flask. The reaction vessel was then equipped with a nitrogen inlet, stainless steel stirrer. The sidearm was attached to a condenser that was connected to a vacuum flask. P solution (0.33 g) was added to the reaction bottle through the side arm at stage 4.

A typical synthesis from DMT is as follows. To make a copolyester than contains 20 mole % CHDA, 80% DMT, 15 mole % NPG, and 85% EG, DMT (69.98 g, 0.36 mol), CHDA (8.24 g, 0.04 mol), EG (29.24 g, 0.47 mol), NPG (14.85 g, 0.14 mol) and 0.33 wt % Ti solution (0.6 g) were charged into a 500 mL bottom flask. Using the sample reaction set-up, the Camille recipe (Table 1) for polymerization was loaded. The polymer composition and IV were analyzed.

The characterization of each resin is captured in Tables 2-9.

TABLE 1
Camille recipe for resin synthesis (left table recipe
is for resins made from TPA/EG oligomer and right
table recipe is for resins made from DMT)

| | Time | Temp | Pressure | Stir |
|---|---|---|---|---|
| Stage No. | (min) | (° C.) | (psi) | (rpm) |
| 1 | 0.1 | 265 | 730 | 0 |
| 2 | 8 | 265 | 730 | 125 |
| 3 | 60 | 265 | 730 | 150 |
| 4 (P addition) | 2 | 265 | 730 | 150 |
| 5 | 5 | 265 | 130 | 150 |
| 6 | 40 | 265 | 130 | 150 |
| 7 | 8 | 275 | 4 | 125 |
| 8 | 42 | 275 | 4 | 75 |
| 9 | 5 | 275 | 0.6 | 75 |
| 10 | 80-120 min | 275 | 0.6 | 75 |
| | (depends) | | | |
| 11 | 2 | 275 | 730 | 0 |

| | Time | Temp | Pressure | Stir |
|---|---|---|---|---|
| Stage No. | (min) | (° C.) | (psi) | (rpm) |
| 1 | 0.1 | 205 | 730 | 0 |
| 2 | 8 | 200 | 730 | 125 |
| 3 | 60 | 200 | 730 | 150 |
| 4 | 5 | 210 | 730 | 150 |
| 5 | 90 | 210 | 730 | 150 |
| 6 (P addition) | 2 | 210 | 730 | 150 |
| 7 | 5 | 265 | 130 | 125 |
| 8 | 40 | 265 | 130 | 125 |
| 9 | 8 | 275 | 4 | 125 |
| 10 | 40 | 275 | 4 | 125 |
| 11 | 5 | 280 | 0.5 | 75 |
| 12 | 90 | 280 | 0.5 | 75 |
| 13 | 2 | 21 | 730 | 0 |

Film Forming Procedure

Pressed films were produced from polymer pellets using a heated, manual pneumatic or hydraulic press. Polymer pellets were dried overnight at 55° C. in a vacuum oven and subsequently pressed into 10 mil films according to the following procedure:
1. Heat press to 250° C.;
2. Weigh out ˜8 g of polymer pellets and place in the center of a 6″ by 6″ by 10 mil shim; Assemble the shim and polymer according to the following configuration in the manual press: press plate, Kapton film, shim and polymer, Kapton film, press plate;
3. Place the preceding configuration between the platens of the manual press and melt the polymer under nominal pressures for approximately 2 minutes;
4. Increase the pressure to 12,000 psi and maintain pressure for approximately 45 seconds;
5. Rapidly release pressure to 0 psi and then immediately increase the pressure to 13,000 psi; Rapidly release pressure to 0 psi and then immediately increase pressure to 14,000 psi; Repeat these steps such that the pressure is continuously released to 0 psi and subsequently increased in increments of 1,000 psi until a final pressure of 16,000 psi is achieved;
6. Hold pressure at 16,000 psi for approximately 45 seconds; then release pressure to 0 psi and remove polymer from press;
7. Cut resultant polymer film out of the shim;
8. Repeat film pressing as necessary.

Pressed films were cut into 181 mm by 181 mm squares and stretched on a Bruckner Karo 4 tenter frame to a final thickness of 50 microns with a 10-second soak time and at a temperature 15° C. above Tg (i.e., 80° C.). A target stretch ratio of 5:1 (TD:MD) was achieved with a stretch rate of 100 mm/min.

Tenter frame film samples were made by extruding and stretching resins samples on a commercial tenter frame (located at Marshall and Williams, a division of Parkinson Technologies) where the film is extruded using a 2.5 inch single screw extruder. The film is cast at a thickness of roughly 10 mil (250 microns) and then stretched with a 5:1 stretch ratio and to a thickness of 50 microns. In general, the cast thickness is 250 microns and the final stretched film thickness is 50 microns. The line speed was 45 fpm.

Shrink Film Property Test

### Shrink Force

Shrink force was determined using a Labthink FST-02 shrink force tester. Shrink force measurements were conducted under the same temperature conditions as the stretching temperatures used to stretch films on the Bruckner (80° C.) and held in the heating chamber for 60 seconds. The maximum shrink force value of each film was measured.

### Shrinkage

Shrinkage was measured by placing a 50 mm by 50 mm square film sample in water at temperatures ranging from 60° C. to 95° C. for 10 seconds without restricting shrinkage in any direction. The percent shrinkage was then calculated by the following equation:

% shrinkage=[(50 mm-length after shrinkage)/50 mm]×100%
Shrinkage was measured in the direction orthogonal to the main shrinkage direction (machine direction, MD) and was also measured in the main shrinkage direction (transverse direction, TD).
Negative shrinkage indicated growth
   Tensile film properties were measured for the examples herein using ASTM Method D882. Multiple film stretching speeds (300 mm/min and 500 mm/min) were used to evaluate the toughness of the films.

The glass transition temperatures and the strain induced crystalline melting points (T_{g} and Tₘ respectively) of the polyesters were determined using a TA DSC 2920 from Thermal Analyst Instrument at a scan rate of 20° C./min. Tm was measured on the 1st heat on stretched samples and Tg was measured during the 2nd heating step. Additionally, samples could be crystallized in a forced air oven at 165° C. for 30 minutes and then analyzed with DSC. For all samples, a crystalline melting point was typically NOT present during the second heat of the DSC scan with a heating rate of 20° C./min.

### EXAMPLES

### Comparative Examples

The composition and film properties of comparative example 1 is shown in Table 2 and Table 3, respectively. Films for Comparative Examples 1 and 4 were produced using the pressed film procedure and film samples for Comparative Examples 2 and 3 were produced using the tenter frame procedure. Specific tenter frame conditions for Comparative Examples 2 and 3 are included in Table 3.

TABLE 2
Comparative Example Composition

| | Comparative | Comparative | Comparative | Comparative |
|---|---|---|---|---|
| Examples | Example 1 | Example 2 | Example 3 | Example 4 |
| Diacid/Diester | | | | |
| TPA | 100 | 100 | 100 | 100 |
| Diol/Glycols | | | | |
| ethylene glycol | 65 | 82 | 81 | 64 |
| CHDM | 23 | 3 | 3 | 21 |
| diethylene | 12 | 4 | 3 | 15 |
| glycol | | | | |
| NPG | | 11 | 13 | |

TABLE 3
Shrink film properties for Comparative Example 1

| | | Examples | | | | | | | |
|---|---|---|---|---|---|---|---|---|---|
| | | Comparative | | Comparative | | Comparative | | Comparative | |
| | | Example 1 | | Example 2 | | Example 3 | | Example 4 | |
| Intrinsic viscosity (dL/g) | | 0.69 | | 0.709 | | 0.703 | | | 0.75 |
| Glass | | 71 | | | | | | | 69 |
| transition | | | | | | | | | |
| temp. (° C.) | | | | | | | | | |
| | Temp. (° C.) | MD | TD | MD | TD | MD | TD | MD | TD |
| Heat | 60 | 0 | 1 | 0 | 1 | −1 | 1 | 0 | 2 |
| shrinkage | 65 | 1 | 2 | 2 | 3 | 2 | 4 | 2 | 18 |
| (%) | 70 | 1 | 21 | 7 | 14 | 6 | 20 | −4 | 42 |
| | 75 | −8 | 48 | 7 | 32 | 3 | 42 | −8 | 60 |
| | 80 | −13 | 65 | 4 | 48 | −1 | 59 | −8 | 72 |
| | 85 | −11 | 73 | 2 | 59 | 0 | 67 | −9 | 77 |
| | 90 | −12 | 77 | 5 | 64 | 2 | 73 | −12 | 80 |
| | 95 | −5 | 78 | 6 | 68 | 3 | 76 | −2 | 80 |

| | | | | | | |
|---|---|---|---|---|---|---|
| shrink rate | | 65-80 | 4.2 | 3.0 | 3.7 | 3.6 |
| (65-80) | | | | | | |
| Shrink force | | | 7.7 | 9.8 | 8.8 | 5.1 |
| (Mpa, <7.7) | | | | | | |
| Strain at break | % | 300 mm/min | 539 | | | 7 |
| | % | 500 mm/min | 45 | 616 | 553 | |
| preheat temp | ° C. | | 78 | 78 | 93 | |
| stretch temp | ° C. | | 78 | 78 | 78 | |
| anneal | ° C. | | 76 | 71 | 71 | |

### Examples 1-3 are Shown in Table 4 and Table 5

1.0 mol %-2.5 mol % DEG was formed from the side reactions during polymerization.

These examples describe polyester resins that can be converted into shrinkable films that meet the requirements for shrink film applications described by this invention. Compared to the shrink film properties data for comparative example 1, example 1, 2, and 3 have slow shrink rates over the entire temperature range, low shrink force, high ultimate shrinkage (measured at 95° C.), and the targeted shrinkage at 60 and 65° C.

TABLE 4
Resin compositions with acid modifications

| Examples | Example 1 | Example 2 | Example 3 |
|---|---|---|---|
| Diacid/Diester (mole %) | | | |
| TPA | | | 93 |
| DMT | 90 | 76 | |
| CHDA | 10 | 24 | |
| Succinic | | | 7 |
| Diol/Glycols (mole %) | | | |
| ethylene glycol | 82 | 90 | 74 |
| CHDM | 18 | | |
| diethylene glycol | 1.05 | <1 | 2 |
| TMCD | | 10 | |
| NPG | | | 24 |

TABLE 5
Shrink film properties data for resins with acid modifications

| | | Examples | | | | | |
|---|---|---|---|---|---|---|---|
| | | Example 1 | | Example 2 | | Example 3 | |
| Inherent viscosity (dL/g) | | 0.69 | | 0.68 | | 0.71 | |
| Glass | | 66 | | 64 | | 66 | |
| transition | | | | | | | |
| temp. (° C.) | | | | | | | |
| | Temp. (° C.) | MD | TD | MD | TD | MD | TD |
| Heat | 60 | 0 | 2 | 0 | 2 | 0 | 2 |
| shrinkage | 65 | 1 | 14 | 0 | 12 | 0 | 9 |
| (%) | 70 | −4 | 34 | −3 | 33 | −4 | 37 |
| | 75 | −11 | 53 | −7 | 53 | −7 | 48 |
| | 80 | −14 | 66 | −5 | 64 | −5 | 60 |
| | 85 | −13 | 72 | −6 | 72 | −6 | 69 |
| | 90 | −10 | 77 | −5 | 75 | −3 | 75 |
| | 95 | −10 | 77 | −4 | 78 | −1 | 78 |

| | | | |
|---|---|---|---|
| shrink rate | 3.5 | 3.5 | 3.4 |
| (65-80) | | | |
| Shrink force | 5.5 | 6.2 | 6.8 |
| (MPa) | | | |

TABLE 5
Resin compositions with acid modifications

| Examples | Example 4 | Example 5 | Example 6 |
|---|---|---|---|
| Diacid/Diester (mole %) | | | |
| TPA | 87 | 89 | 96 |
| Adipic | 13 | 11 | 4 |
| Diol/Glycols (mole %) | | | |
| ethylene glycol | 82 | 76 | 71 |
| CHDM | | 24 | |
| diethylene glycol | <1 | <1 | 2 |
| TMCD | 17 | | |
| NPG | | | 27 |

TABLE 6
Shrink film properties data for resins with acid modifications

| | | Examples | | | | | |
|---|---|---|---|---|---|---|---|
| | | Example 4 | | Example 5 | | Example 6 | |
| Inherent viscosity (dL/g) | | 0.68 | | 0.78 | | 0.78 | |
| Glass | | 64 | | 60 | | 68 | |
| transition | | | | | | | |
| temp. (° C.) | | | | | | | |
| | Temp. (° C.) | MD | TD | MD | TD | MD | TD |
| Heat | 60 | 0 | 2 | 0 | 3 | 0 | 1 |
| shrinkage | 65 | 0 | 4 | 0 | 22 | 0 | 6 |
| (%) | 70 | −3 | 22 | 0 | 34 | −3 | 22 |
| | 75 | −11 | 43 | 0 | 41 | −6 | 49 |
| | 80 | −9 | 54 | −4 | 50 | −7 | 67 |
| | 85 | −13 | 60 | −4 | 58 | −5 | 75 |
| | 90 | −6 | 62 | 1 | 62 | −4 | 77 |
| | 95 | −11 | 68 | 2 | 70 | 1 | 78 |

| | | | |
|---|---|---|---|
| shrink rate | 3.3 | 1.9 | 4.0 |
| (65-80) | | | |
| Shrink force | 6.3 | 4.7 | 7.1 |
| (MPa) | | | |

These examples describe polyester resins that can be converted into shrinkable films that meet the requirements for shrink film applications described by this invention. Compared to the shrink film properties data for comparative examples 1-4, examples 1-13 have slow shrink rates over the entire temperature range, low shrink force, high ultimate shrinkage (measured at 95° C.), and the targeted shrinkage at 60 and 65° C.

TABLE 7
Resin compositions with glycol modifications

| Examples | Example 7 | Example 8 | Example 9 | Example 10 |
|---|---|---|---|---|
| Diacid/Diester | | | | |
| (mole %) | | | | |
| TPA | 100 | 100 | 100 | 100 |
| Diol/Glycols | | | | |
| (mole %) | | | | |
| ethylene glycol | 61.5 | 62 | 65.6 | 70 |
| CHDM | | 5 | | |
| diethylene glycol | 2 | 2 | 0 | 8 |
| TMCD | | | 3.4 | 5 |
| NPG | 5.5 | | | |
| 1,3-propanediol | 31 | 31 | 31 | 17 |

TABLE 8
Shrink film properties data for resins made with glycol modifications

| | | Examples | | | | | | | |
|---|---|---|---|---|---|---|---|---|---|
| | | Example 7 | | Example 8 | | Example 9 | | Example 10 | |
| Inherent viscosity (dL/g) | | 0.66 | | 0.66 | | 0.65 | | 0.71 | |
| Glass | | 66 | | 67 | | 68 | | 67 | |
| transition | | | | | | | | | |
| temp. (° C.) | | | | | | | | | |
| | Temp. (° C.) | MD | TD | MD | TD | MD | TD | MD | TD |
| Heat | 60 | 0 | 2 | 0 | 1 | 0 | 1 | 0 | 1 |
| shrinkage | 65 | 3 | 28 | 1 | 13 | 0 | 7 | 0 | 14 |
| (%) | 70 | 2 | 30 | −6 | 31 | −2 | 22 | −2 | 23 |
| | 75 | −6 | 43 | −8 | 46 | −6 | 48 | −5 | 44 |
| | 80 | −6 | 54 | −8 | 53 | −7 | 50 | −6 | 53 |
| | 85 | −8 | 59 | −7 | 57 | −7 | 58 | −6 | 59 |
| | 90 | −5 | 63 | −9 | 60 | −5 | 62 | −5 | 64 |
| | 95 | −5 | 72 | −8 | 70 | −5 | 68 | −3 | 72 |
| shrink rate | | 1.7 | | 2.7 | | 2.9 | | 2.6 | |
| (65-80) | | | | | | | | | |
| Shrink force | | 6.2 | | 4.8 | | 6.3 | | 6.4 | |
| (MPa) | | | | | | | | | |

TABLE 9
Shrink film properties data for resins
made with glycol modifications

| Examples | Example 11 | Example 12 | Example 13 |
|---|---|---|---|
| Diacid/Diester (mole %) | | | |
| TPA | 100 | 100 | 100 |
| Diol/Glycols (mole %) | | | |
| ethylene glycol | 65 | 72 | 62 |
| diethylene glycol | 2 | 13 | 14 |
| NPG | 17 | | |
| 1,4-butanediol | 16 | | |
| CHDM dimer | | 15 | |
| 1,3-CHDM | | | 24 |

TABLE 10
Shrink film properties data with glycol modifications

| | | | Examples | | | | | |
|---|---|---|---|---|---|---|---|---|
| | | | Example 11 | | Example 12 | | Example 13 | |
| Inherent viscosity (dL/g) | | | 0.72 | | 0.75 | | 0.8 | |
| Glass | <70° C. | | 68 | | 60 | | 66 | |
| transition | | | | | | | | |
| temp. (° C.) | | | | | | | | |
| | | Temp. (° C.) | MD | TD | MD | TD | MD | TD |
| Heat | | 60 | 0 | 1 | 0 | 1 | 0 | 1 |
| shrinkage | | 65 | 1 | 5 | 0 | 6 | −4 | 27 |
| (%) | | 70 | 1 | 17 | −5 | 36 | −10 | 55 |
| | | 75 | −6 | 41 | −6 | 47 | −12 | 67 |
| | | 80 | −6 | 60 | −9 | 60 | −3 | 74 |
| | | 85 | −7 | 69 | −7 | 67 | −2 | 80 |
| | | 90 | −4 | 74 | −5 | 73 | −1 | 80 |
| | | 95 | −13 | 77 | −4 | 70 | −5 | 80 |
| shrink rate | | | 3.7 | | 3.6 | | 3.1 | |
| (65-80) | | | | | | | | |
| Shrink force | | | 7.0 | | 5.7 | | 7.0 | |
| (MPa) | | | | | | | | |

The invention has been described in detail with particular reference to certain embodiments thereof, but it will be understood that variations and modifications can be effected within the spirit and scope of the invention.

1. A polyester which comprises:
i. a dicarboxylic acid component comprising:
1. greater than about 75 mole percent of terephthalic acid residues;
2. about 0 to about 25 mole percent of residues of 1,4-cyclohexanedicarboxylic acid or succinic acid; and
ii. a diol component comprising:
1. about 60 to 90 mole percent of ethylene glycol residues; and
2. about 0 to about 30 mole percent of residues chosen from neopentyl glycol, 1,4-cyclohexanedimethanol, and 2,2,4,4-tetramethyl-1,3-cyclobutanediol; and
3. about 0 to about 15 mole percent of diethylene glycol residues; and
4. about 0 to about 35 mole percent of one or more of triethylene glycol, 1,3-propanediol, and 1,4-butanediol;
provided that the diol component is other than 2-methyl-1,3-propanediol,
wherein the total mole percent of the dicarboxylic acid component is 100 mole percent, and wherein the total mole percent of the diol component is 100 percent.

2. The polyester of claim 1, wherein the dicarboxylic acid component comprises greater than about 95 mole percent of residues of terephthalic acid.

3. The polyester of claim 1, wherein the dicarboxylic acid component comprises about 8 to about 25 mole percent of residues of 1,4-cyclohexanedicarboxylic acid.

4. The polyester of claim 1, wherein the dicarboxylic acid component further comprises about 5 to about 10 mole percent of residues of succinic acid.

5. The polyester of claim 1, wherein the dicarboxylic acid component comprises about 3 to about 15 mole percent of residues of adipic acid.

6. The polyester of claim 1, wherein the diol component comprises:
a. about 5 to about 30 mole percent of residues of neopentyl glycol; or
b. about 5 to about 30 mole percent of residues of 1,4-cyclohexanedimethanol; or
c. about 5 to about 30 mole percent of residues of 2,2,4,4-tetramethyl-1,3-cyclobutanediol.

7. The polyester of claim 1, wherein the diol component comprises about 2 to about 14 mole percent of residues of diethylene glycol.

8. The polyester of claim 1, wherein the diol component comprises about 10 to about 31 mole percent of residues of one or more of triethylene glycol; 1,3-propanediol; and 1,4-butanediol residues.

9. The polyester of claim 1, further comprising about 5 to about 25 mole percent of one or more dicarboxylic acid residues chosen from glutaric, azelaic, sebacic, 1,3-cyclohexanedicarboxylic, adipic, hexahydrophthalic anhydride, and isophthalic acids.

10. The polyester of claim 1, further comprising about 5 to about 30 mole percent of one or more diol residues chosen from 2,2,4-trimethyl-1,3-pentanediol; 2-propoxy-1,3-propanediol; 1,3-cyclohexanediol; and a compound of the formula

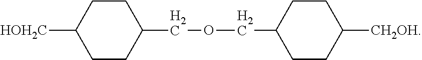 [SMILES: OCC1CCC(COCC2CCC(CO)CC2)CC1]

11. The polyester of claim 1 wherein the polyester comprises:
a. a dicarboxylic acid component comprising:
i. about 88 to 92 mole percent of residues of terephthalic acid; and
ii. about 8 to about 12 mole percent of residues of 1,4-cyclohexanedicarboxylic acid; and
b. a diol component comprising:
i. about 80 to about 86 mole percent of residues of ethylene glycol; and
ii. about 16 to about 20 mole percent of residues of 1,4-cyclohexanedimethanol; or.
wherein the polyester comprises:
a. a dicarboxylic acid component comprising:
i. about 74 to about 78 mole percent of residues of terephthalic acid; and
ii. about 22 to about 26 mole percent of residues of 1,4-cylohexanedicarboxylic acid; and
b. a diol component comprising:
i. about 88 to about 92 mole percent of residues of ethylene glycol; and
ii. about 8 to about 12 mole percent of residues of 2,2,4,4-tetramethyl-1,3-cyclobutanediol; or
wherein the polyester comprises:
a. a dicarboxylic acid component comprising:
i. about 91 to about 95 mole percent of residues of terephthalic acid; and
ii. about 5 to about 9 mole percent of residues of succinic acid; and
b. a diol component comprising:
iii. about 72 to about 76 mole percent of residues of ethylene glycol;
iv. about 1 to about 3 mole percent of residues of diethylene glycol; and
v. about 22 to about 26 mole percent of residues of neopentyl glycol.

12. The polyester of claim 1, wherein the polyester comprises:
a. a dicarboxylic acid component comprising:
i. about 98 to about 100 mole percent of residues of terephthalic acid; and
b. a diol component comprising:
i. about 60 to about 63 mole percent of residues of ethylene glycol;
ii. up to about 4 mole percent of residues of diethylene glycol;
iii. about 4 to about 7 mole percent of residues of neopentyl glycol; and
iv. about 29 to about 33 mole percent of residues of 1,3-propanediol; or
wherein the polyester comprises:
a. a dicarboxylic acid component comprising:
i. about 98 to about 100 mole percent of residues of terephthalic acid; and
b. a diol component comprising:
i. about 60 to about 64 mole percent of residues of ethylene glycol;
ii. about 3 to about 7 mole percent of residues of 1,4-cyclohexanedimethanol;
iii. up to about 4 mole percent of residues of diethylene glycol; and
iv. about 29 to about 33 mole percent of residues of 1,3-propanediol; or
wherein the polyester comprises:
a. a dicarboxylic acid component comprising:
i. about 98 to about 100 mole percent of residues of terephthalic acid; and
b. a diol component comprising:
i. about 64 to about 68 mole percent of residues of ethylene glycol;
ii. about 2 to about 6 mole percent of residues of 2,2,4,4-tetramethyl-1,3-cyclobutanediol; and
iii. about 29 to about 33 mole percent of residues of 1,3-propanediol.

13. The polyester of claim 1, wherein the polyester comprises:
a. a dicarboxylic acid component comprising:
i. about 98 to about 100 mole percent of residues of terephthalic acid; and
b. a diol component comprising:
i. about 68 to about 72 mole percent of residues of ethylene glycol;
ii. about 6 to about 10 mole percent of residues of diethylene glycol;
iii. about 3 to about 7 mole percent of residues of 2,2,4,4-tetramethyl-1,3-cyclobutanediol; and
iv. about 15 to about 19 mole percent of residues of 1,3-propanediol; or
wherein the polyester comprises:
a. a dicarboxylic acid component comprising:
i. about 98 to about 100 mole percent of residues of terephthalic acid;
b. a diol component comprising:
i. about 63 to about 67 mole percent of residues of ethylene glycol;
ii. up to about 4 mole percent of residues of diethylene glycol;
iii. about 15 to about 19 mole percent of residues of neopentyl glycol; and
iv. about 14 to about 18 mole percent of 1,4-butanediol.

14. The polyester of claim 1, wherein the polyester comprises:
a. a dicarboxylic acid component comprising:
i. about 98 to about 100 mole percent of residues of terephthalic acid;
b. a diol component comprising:
i. about 70 to about 74 mole percent of residues of ethylene glycol;
ii. about 11 to about 15 mole percent of residues of diethylene glycol; and
iii. about 13 to about 17 mole percent of residues of a compound of the formula:

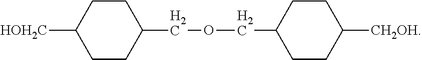 [SMILES: OCC1CCC(COCC2CCC(CO)CC2)CC1]

15. The polyester of claim 1, wherein the polyester comprises:
a. a dicarboxylic acid component comprising:
i. about 98 to about 100 mole percent of residues of terephthalic acid;
b. a diol component comprising:
i. about 60 to about 64 mole percent of residues of ethylene glycol;
ii. about 12 to about 16 mole percent of residues of diethylene glycol; and
iii. about 22 to about 26 mole percent of residues of 1,3-cyclohexanedimethanol.

16. The polyester of claim 5, wherein the polyester comprises:
a. a dicarboxylic acid component comprising:
i. about 85 to 97 mole percent of residues of terephthalic acid;
ii. about 3 to about 15 mole percent of residues of adipic acid;
b. a diol component comprising:
i. about 70 to about 85 mole percent of residues of ethylene glycol;
ii. about 0 to about 25 mole percent of residues of 1,4-cyclohexanedimethanol;
iii. about 0.1 to about 2 mole percent of residues of diethylene glycol;
iv. about 0 to about 18 mole percent of residues of 2,2,4,4-tetramethyl-1,3-cyclobutanediol; and
v. about 0 to about 27 mole percent of residues of neopentyl glycol.

17. A shrinkable film, comprising the polyester of claim 1.

18. An article of manufacture, a shaped article, a container, a plastic bottle, a glass bottle, packaging, a battery, a hot fill container, or an industrial article, having applied thereto a label or sleeve, wherein said label or sleeve is comprised of the shrink film of claim 1.

19. A molded article, thermoformed sheet, extruded sheet or film comprising the polyester of claim 1.

20. A shrinkable film comprising the polyester of claim 1, which exhibits one or more of the following properties:
A. TD shrinkage @60° C.
B. TD shrinkage @65° C. between 0 and 35%;
C. TD shrinkage @95° C. >60%;
D. Shrink rate <4%/° C. between 65 and 80° C.;
E. Shrink force <8 MPa, measured at 80° C.;
F. Tg<70° C.;
a break strain percentage of greater than 100% at pull rates of 300 mm/minute, in the transverse direction or in the machine direction or in both directions according to ASTM Method D882.
